(19) United States
(12) Patent Application Publication
(10) Pub. No.: US 2011/0317103 A1
(43) Pub. Date: Dec. 29, 2011

(54) LIQUID CRYSTAL DISPLAY PANEL

(76) Inventors: Wen-Hsien Tseng, Hsin-Chu (TW); Yen-Heng Huang, Hsin-Chu (TW); Chia-Hui Pai, Hsin-Chu (TW); Chung-Kai Chen, Hsin-Chu (TW); Wei-Yuan Cheng, Hsin-Chu (TW); Yi-Jen Huang, Hsin-Chu (TW)

(21) Appl. No.: 12/975,380

(22) Filed: Dec. 22, 2010

(30) Foreign Application Priority Data
Jun. 23, 2010 (TW) 099120520

(51) Int. Cl. G02F 1/1335

(52) U.S. Cl. 349/106

(57) ABSTRACT

A liquid crystal display panel includes a first substrate, a second substrate, a liquid crystal layer, pixel regions, pixel electrodes and color filters. Each pixel region at least includes a main pixel region and a sub pixel region. Each pixel electrode is disposed on the first substrate. Each pixel electrode includes a first electrode disposed in the main pixel region and a second electrode disposed in the sub pixel region. Each color filter is disposed between the first substrate and the second substrate and corresponds to each pixel region. Each color filter includes a curved surface facing the liquid crystal layer and an extreme thickness position. When a predetermined voltage is applied to each pixel electrode, aligning directions of the liquid crystal molecules disposed above the first electrode are converged toward a center. The extreme thickness position substantially overlaps the center in a vertical projection direction.

### BACKGROUND OF THE INVENTION

1. Field of the Invention

The present invention relates to a liquid crystal display panel, and more particularly, to a liquid crystal display panel in which structures of pixel electrodes and color filters are capable of keeping liquid crystal molecules from generating disclination issue.

2. Description of the Prior Art

Compared to conventional cathode ray tube (CRT) displays, liquid crystal display (LCD) panels have become a mainstream product in the display market because of certain advantages, such as light weight, low volume, low power consumption, and radiation-free characteristics. But there are many problems with the conventional liquid crystal display panel needed to be overcome, such as narrow viewing angle.

A technology, known as multi-domain vertical alignment (MVA) technology, has been developed for enhancing viewing angles. In MVA technology, a protrusion for alignment is formed in the liquid crystal display panel or the pixel electrode is designed to have a particular pattern. Accordingly, the liquid crystal molecules will be tilted slightly in the condition without applying a voltage to the pixel electrode. When a voltage is applied to the pixel electrode, the liquid crystal molecules will be aligned quickly in a predetermined direction from the slightly tilted stage, the response time of the liquid display panel can be reduced significantly, and the wide viewing angle effect can be achieved. Additionally, because the problems, such as color washout or gamma curve shifting, are common issues of the MVA technology, the pixel region of the conventional liquid crystal display panel may be divided into a main pixel region and a sub pixel region with different pixel electrodes to improve the color washout issue.

Please refer to FIG. 1 and FIG. 2. FIG. 1 and FIG. 2 are schematic diagrams illustrating the structure of the pixel region of the liquid crystal display panel according to the prior art, wherein FIG. 2 is a schematic diagram illustrating a cross-sectional view along the line A-A′ in FIG. 1. As shown in FIG. 1, a pixel region 102 of the conventional liquid crystal display panel 100 comprises a main pixel region 104 and a sub pixel region 106. The area of the main pixel region 104 is substantially equal to the area of the sub pixel region 106. A first electrode 108 is disposed in the main pixel region 104, and a second electrode 110 is disposed in the sub pixel region 106, wherein a pattern of the first electrode 108 and a pattern of the second electrode 110 are completely identical to each other, and the first electrode 108 is electrically disconnected from the second electrode 110. For achieving the above-mentioned wide viewing angle effect, the conventional first electrode 108 and second electrode 110 respectively comprise branch electrodes stretching to outside in different directions, and the branch electrodes may influence the alignment of the liquid crystal molecules and respectively divide the main pixel region 104 and the sub pixel region 106 into several regions. In other words, when applying voltages to the first electrode 108 and the second electrode 110, the liquid crystal molecules 120 (shown in FIG. 2) disposed on the first electrode 108 and the second electrode 110 may be tilted along the shape of the electrodes, i.e. along the directions of the arrows B in FIG. 1, due to the electric field effect. According to FIG. 1, the liquid crystal molecules in different regions may be tilted along different directions of the arrows B to achieve the wide viewing angle effect.

Some new problems may be generated by the electrode design described above. As shown in FIG. 2, inkjet printing is one of the methods nowadays for forming color filters. The color filter inkjet printing comprises: forming a black matrix 114 on a substrate 112 by inkjet printing, and dropping color pigment on regions, which are not covered by the black matrix 114, on the substrate 112 to form the color filters 116 after a solidification reaction. So the color filter 116 and the black matrix 114 may be quickly formed on the substrate 112. However, the color filters 116 formed by this method usually have a curved surface 118 and an extreme thickness position 122 facing a center of the pixel region 102. The center of the pixel region 102 is the position equally dividing the pixel region 102 into two regions with an equal area. In FIG. 1, the center of the pixel region 102 is exactly located on and around the boundary region between the first electrode 108 and the second electrode 110. The curved surface 118 may have a considerable effect on the alignment of the liquid crystal molecules. For example, please refer to FIG. 1 again, the maximum thickness position 122 of the curved surface 118 is located on the center of the pixel region 102, and that may force the liquid crystal molecules 120 under the curved surface 118 to be tilted along the directions of the arrows C. If the aligning directions of the arrows B are combined with the aligning directions of the arrows C, a twisting force may be generated on the liquid crystal molecules 120 along the directions of arrows D. If the liquid crystal molecules 120 are tilted along the twist directions of the non-linear arrows D, a non-uniform alignment of the liquid crystal molecules 120 may be generated, which is so-called a disclination. The disclination of the liquid crystal molecules may generate light leakage issue on the liquid crystal display panel and worsen the display quality, and the disclination of the liquid crystal molecules is an urgent issue to be solved.

### SUMMARY OF THE INVENTION

It is one of the objectives of the present invention to provide a liquid crystal display panel in which structures of pixel electrodes and color filters are capable of effectively keeping liquid crystal molecules from generating disclination issue.

To achieve the purpose described above, the present invention provides a liquid crystal display panel comprising a first substrate, a second substrate, a liquid crystal layer, a plurality of pixel regions, a plurality of pixel electrodes, and a plurality of color filters. The first substrate is disposed oppositely to the second substrate. The liquid crystal layer is disposed between the first substrate and the second substrate, and the liquid crystal layer comprises a plurality of liquid crystal molecules. Each of the pixel regions at least comprises a main pixel region and a sub pixel region. The pixel electrode is disposed on the first substrate and disposed correspondingly to the pixel region, wherein each of the pixel electrodes comprises a first electrode and a second electrode. The first electrode is disposed in the main pixel region, and the second electrode is disposed in the sub pixel region, wherein the first electrode is electrically disconnected from the second electrode. The color filters are disposed between the first substrate and the second substrate, and each of the color filters corresponds to each of the pixel regions. Each of the color filters comprises a curved surface facing the liquid crystal layer, and each of the color filters comprises an extreme thickness position. When a predetermined voltage is applied to each of the pixel electrodes, aligning directions of the liquid crystal molecules disposed above the first electrode are converged toward a center, and the extreme thickness position substantially overlaps the center in a vertical projection direction.

The influence of the curved surface of the color filter on the aligning directions of the liquid crystal molecules is considered in the present invention. When a predetermined voltage is applied to each of the pixel electrodes, the aligning directions of the liquid crystal molecules disposed above the first electrode are converged toward a center, and the extreme thickness position substantially overlaps the center to reduce the influence of the color filters on the alignment of the liquid crystal molecules to a lowest level. So the disclination of the liquid crystal molecules may be effectively avoided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-2 are schematic diagrams illustrating the structure of the pixel region of the liquid crystal display panel according to the prior art.

FIG. 3 is a schematic diagram illustrating a three-dimensional view of the liquid crystal display panel according to an embodiment of the present invention.

FIG. 4 is a schematic diagram illustrating a planar view of the pixel electrode of the liquid crystal display panel according to an embodiment of the present invention.

FIG. 5 is a schematic diagram illustrating a cross-sectional view of the pixel region of the liquid crystal display panel according to an embodiment of the present invention.

FIG. 6 is a schematic diagram illustrating a cross-sectional view of the pixel region of the liquid crystal display panel according to another embodiment of the present invention.

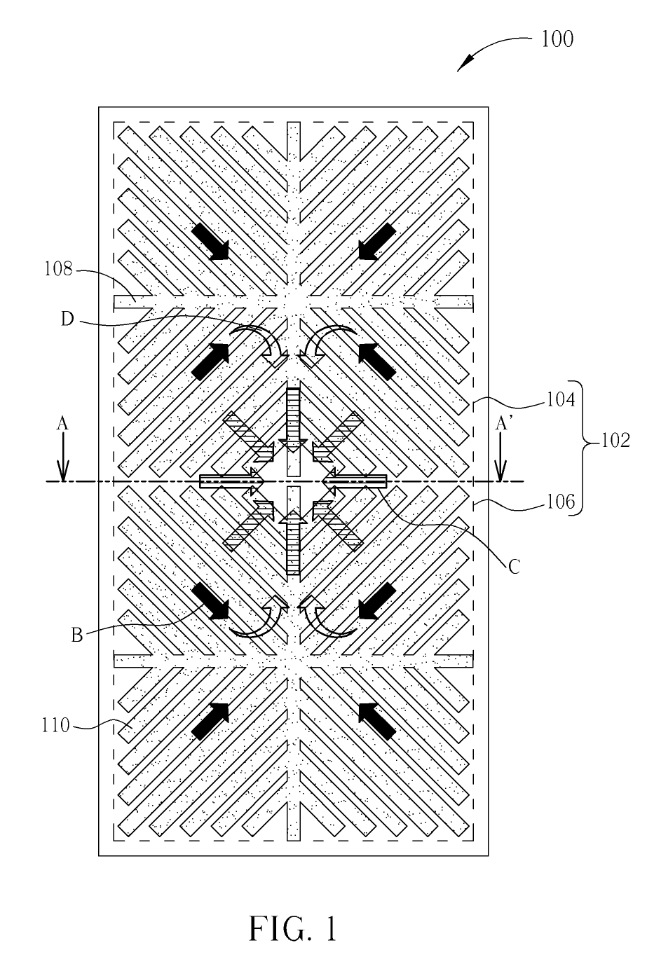

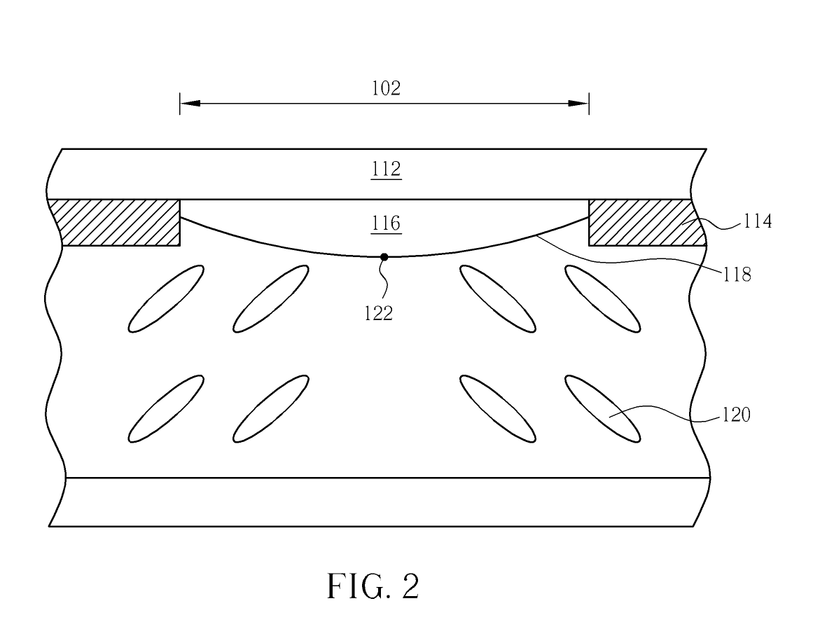

### DETAILED DESCRIPTION

To provide a better understanding of the present invention to the skilled users in the technology of the present invention, preferred embodiments will be detailed as follows. The preferred embodiments of the present invention are illustrated in the accompanying drawings with numbered elements to elaborate the contents and effects to be achieved.

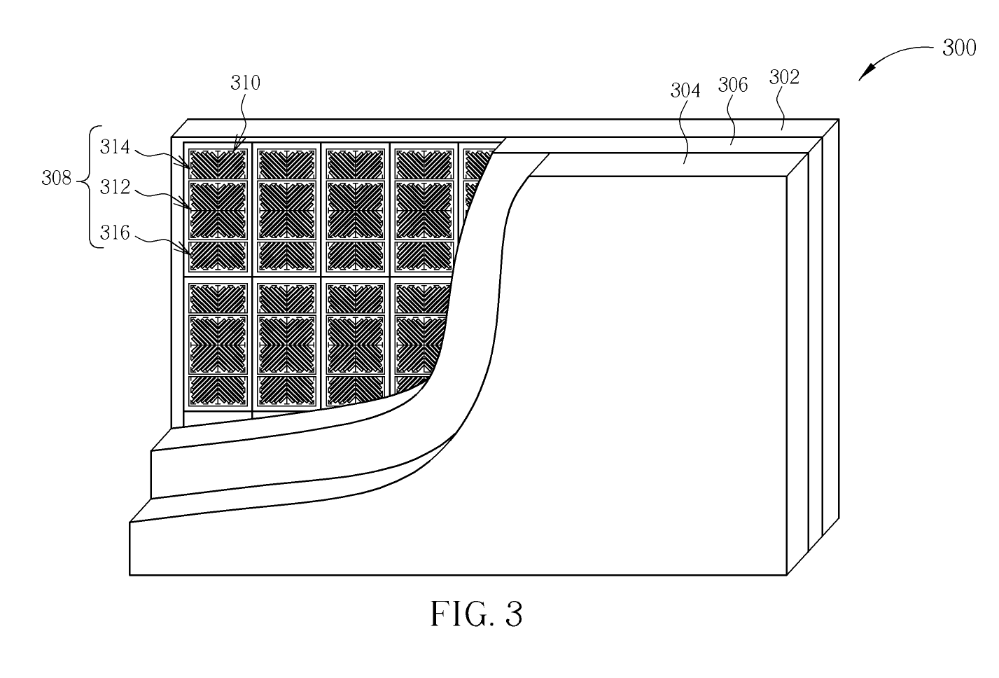

Please refer to FIG. 3. FIG. 3 is a schematic diagram illustrating a three-dimensional view of the liquid crystal display panel according to an embodiment of the present invention. As shown in FIG. 3, the liquid crystal display panel 300 of the present invention comprises a first substrate 302, a second substrate 304, and a liquid crystal layer 306. The first substrate 302 and the second substrate 304 are substantially parallel and disposed oppositely to each other. The liquid crystal layer 306 is disposed between the first substrate 302 and the second substrate 304. There are a plurality of pixel regions 308 on the first substrate 302 and the second substrate 304. Each of the pixel regions 308 comprises at least a scan line (not shown) and at least a data line (not shown) to separately present different display images. Each of the pixel regions may further be divided into at least a main pixel region 312, a first sub pixel region 314 and a second sub pixel region 316. In a preferred embodiment of the present invention, the sequences from a top to a bottom of the pixel region are the first sub pixel region 314, the main pixel region 312, and the second sub pixel region 316. The main pixel region 312 may be disposed between the first sub pixel region 314 and the second sub pixel region 316 in the same pixel region 308. Preferably, the area of the first sub pixel region 314 is substantially equal to the area of the second sub pixel region 316, and the sum of the area of the first sub pixel region 314 and the area of the second sub pixel region 316 is substantially equal to the area of the main pixel region 312, but the present invention is not limited to this. In other embodiments, the area of the first sub pixel region 314 may selectively be substantially different from the area of the second sub pixel region 316, and the sum of the area of the first sub pixel region 314 and the area of the second sub pixel region 316 may selectively be substantially different from the area of the main pixel region 312. In the preferred embodiments of the present invention, the shape of the pixel region 308 is a rectangle, but the present invention is not limited to this. In other embodiments, the shape of the pixel region 308 may be a triangle, a hexagon, a pentagon, a square, a rhombus, a trapezoid, or other appropriate shapes. In addition, a pixel electrode 310 is disposed in each of the pixel regions 308. The pixel electrode 310 may be made of a single layer or multiple layers. The material of the pixel electrode may includes a transparent conductive material (such as indium tin oxide (ITO), indium zinc oxide (IZO), cadmium tin oxide (CTO), aluminum zinc oxide (AZO), indium tin zinc oxide (ITZO), or other appropriate materials), and a reflective material (such as gold (Au), silver (Ag), copper (Cu), aluminum (Al), molybdenum (Mo), titanium (Ti), tantalum (Ta), other appropriate materials, an alloy of the above-mentioned materials, a nitride of the above-mentioned materials, an oxide of the above-mentioned materials, or an oxynitride of the above-mentioned materials). In the embodiments of the present invention, the pixel electrode 310 is made of a transparent conductive material, but the present invention is not limited to this.

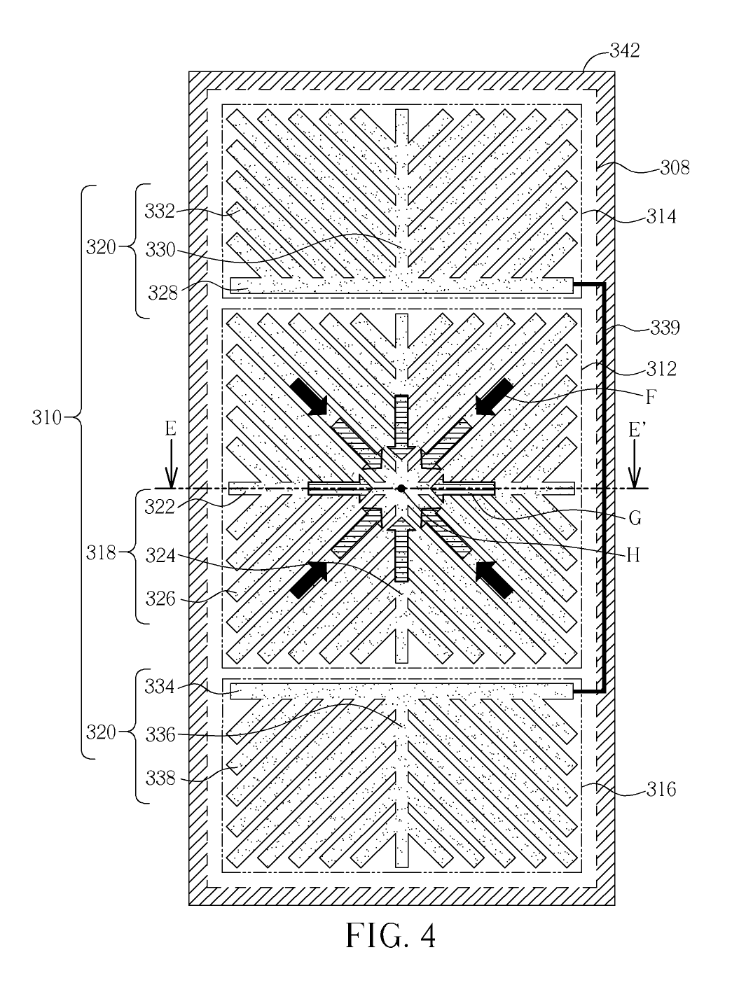

For detail descriptions of the pixel electrode 310, please refer to FIG. 4. FIG. 4 is a schematic diagram illustrating a planar view of the pixel electrode of the liquid crystal display panel according to an embodiment of the present invention. As shown in FIG. 4, the pixel electrode 310 comprises a first electrode 318 and a second electrode 320. The first electrode 318 is disposed in the main pixel region 312, and the second electrode 320 is disposed in the first sub pixel region 314 and the second pixel region 316. The first electrode 318 is electrically disconnected from the second electrode 320. By providing different voltages to the first electrode 318 and the second electrode 320, the color shift issue in large viewing angle may be improved in the liquid crystal display panel 300 of the present invention. In this embodiment, the first electrode 318 comprises a first main electrode (or namely a first trunk electrode) 322, a first main electrode (or namely a first trunk electrode) 324, and a plurality of branch electrodes 326. The first main electrode 322 and the first main electrode 324 are disposed in a center of the main pixel region 312. The first main electrode 322 and the first main electrode 324 are crossed at a point H, and the first main electrode 322 and the first main electrode 324 divide the main pixel region 324 into at least four regions. In the preferred embodiment of the present invention, the first main electrode 322 and the first main electrode 324 are substantially perpendicular to each other and crossed at the point H to present a pattern such as a cross shape, but the present invention is not limited to this. In other embodiments, when the first main electrode 322 and the first main electrode 324 are crossed at the point H, an included angle between the first main electrode 322 and the first main electrode 324 is selectively between about 0 and about 180 degrees. One end of each of the branch electrodes 326 is connected to the first main electrode 322 or the first main electrode 324, and the other end of each of the branch electrodes 326 is disposed apart from the first main electrode 322 and the first main electrode 324. The first branch electrodes 326 disposed in the same region are substantially parallel to each other and stretch in an identical direction. For instance, stretching angles of the first branch electrodes 326 in the four above-mentioned regions are respectively between about 40 degrees and about 50 degrees, between about 130 degrees and about 140 degrees, between about 220 degrees and about 230 degrees, and between about 310 degrees and about 320 degrees. The preferred values of the stretching angles are respectively about 45 degrees, about 135 degrees, about 225 degrees, and about 315 degrees. In other embodiments of the present invention, the first electrode 318 in the main pixel region 312 may comprise other patterns of electrode, such as four main electrodes dividing the main pixel region 312 into eight regions, or eight main electrodes dividing the main pixel region 312 into sixteen regions. The rule of designing the first electrode 318 is that the pattern of the first electrode 318 must have a centroid (such as the point H), and preferably, the centroid (or namely the center of figure, or the center of form) may be disposed at the center of the main pixel region 312. The center of the main pixel region 312 is a position that equally divides the main pixel region 312 into two regions with an identical area. In another embodiment of the present invention, the first electrode 318 may present a point symmetrical pattern in which the centroid is used as a point symmetrical center, and however, the centroid of the first electrode 318 may not correspond to the center of the main pixel region 312.

In this embodiment, the second electrode 320 comprises a second main electrode (or namely a second trunk electrode) 328, a second main electrode 330, a plurality of second branch electrodes 332, a third main electrode (or namely a third trunk electrode) 334, a third main electrode 336, and a plurality of third branch electrodes 338. The second main electrode 328, the second main electrode 330 and the second branch electrodes 332 are disposed in the first sub pixel region 314. The third main electrode 334, the third main electrode 336 and the third branch electrodes 338 are disposed in the second sub pixel region 316. The second main electrode 328 and the second main electrode 330 are crossed to each other and divide the first sub pixel region 314 into at least two regions. Also, an end of the second main electrode 330 connected to the second main electrode 328 does not protrude from a lateral side of the second main electrode 328. In other embodiments, an end of the second main electrode 330 connected to the second main electrode 328 may slightly protrude from the lateral side of the second main electrode 328, and a length of the protrusion is substantially equal to or smaller than the width of the second main electrode 328 (such as a short side of the second main electrode 328). In this embodiment of the present invention, the second main electrode 328 and the second main electrode 330 are substantially crossed and perpendicular to each other to present a pattern such as a reversed T. In other embodiments, when the second main electrode 328 and the second main electrode 330 are crossed at some point, an included angle between the second main electrode 328 and the second main electrode 330 is selectively between about 0 and about 180 degrees. An end of each of the second branch electrodes 332 is connected to the second main electrode 328 or the second main electrode 330, and the other end of the each of the second branch electrodes 332 is disposed apart from the second main electrode 328 and the second main electrode 330. The second branch electrodes 332 disposed in the same region are substantially parallel to each other and stretch in an identical direction. For instance, stretching angles of the second branch electrodes 332 in the two above-mentioned regions are respectively between about 40 degrees and about 50 degrees, and between about 130 degrees and about 140 degrees. The preferred values of the stretching angles are respectively about 45 degrees and about 135 degrees. The third main electrode 334 and the third main electrode 336 are crossed to each other and divide the second sub pixel region 316 into at least two regions. An end of the third main electrode 336 connected to the third main electrode 334 does not protrude from a lateral side of the third main electrode 334. In other embodiments, an end of the third main electrode 336 connected to the third main electrode 334 may slightly protrude from the lateral side of the third main electrode 334, and a length of the protrusion is substantially equal to or smaller than the width of the third main electrode 334 (such as a short side of the third main electrode 334). In this embodiment of the present invention, the third main electrode 334 and the third main electrode 336 are substantially crossed and perpendicular to each other to present a pattern such as a reversed T. In other embodiments, when the third main electrode 334 and the third main electrode 336 are crossed at some point, an included angle between the third main electrode 334 and the third main electrode 336 is selectively between about 0 degree and about 180 degrees. An end of each of the third branch electrodes 338 is respectively connected to the third main electrode 334 or the third main electrode 336, and the other end of the each of the third branch electrodes 338 is disposed apart from the third main electrode 334 and the third main electrode 336. The third branch electrodes 338 disposed in the same region are substantially parallel to each other and stretch in an identical direction. For instance, stretching angles of the third branch electrodes 338 in the two above-mentioned regions are respectively between about 220 degrees and about 230 degrees, and between about 310 degrees and about 320 degrees. The preferred values of the stretching angles are respectively about 225 degrees and about 315 degrees. In other embodiments of the present invention, the second electrode 320 may comprise more than two second main electrodes to divide the first sub pixel region 314 into more than two regions, and the second electrode 320 may comprise more than two third main electrodes to divide the second sub pixel region 316 into more than two regions. In this embodiment of the present invention, the second electrode 320 in the first sub pixel region 314 (which includes the second main electrode 328, the second main electrode 330, and the second branch electrode 332) may correspond to the second electrode 320 in the second sub pixel region 316 (which includes the third main electrode 334, the third main electrode 336, and the third branch electrode 338), and preferably, the point H is used as a symmetrical center, but the present invention is not limited to this.

The second electrode 320 disposed in the first sub pixel region 314 and the second electrode 320 disposed in the second sub pixel region 316 are electrically connected to each other through at least a connecting line 339. In a preferred embodiment of the present invention, the connecting line 339 may electrically connect the second main electrode 328 and the third main electrode 334, but the present invention is not limited to this. For example, depending on the demand of the design, the connecting line 339 may connect the second main electrode 328 and the third main electrode 336, connect the second branch electrode 332 and the third branch electrode 338, connect the second branch electrode 332 and the third main electrode 334, connect the third branch electrode 338 and the second main electrode 328, connect the second branch electrode 332 and the third main electrode 336, or connect the third branch electrode 338 and the second main electrode 330. In another embodiment of the present invention, there may be two or more connecting lines 339. Take two connecting lines as an example, one of the connecting lines 339 is disposed on a left side of the main pixel region 312, and the other one of the connecting lines 339 is disposed on a right side of the main pixel region 312. Additionally, for increasing the conductivity of the connecting line 339, the connecting line 339 in this embodiment may be made of conductive materials, and be made of a single layer or multiple layers structure. The materials of the connecting line 339 may include a transparent conductive material (such as indium tin oxide (ITO), indium zinc oxide (IZO), cadmium tin oxide (CTO), aluminum zinc oxide (AZO), indium tin zinc oxide (ITZO), or other appropriate materials), and a reflective material (such as gold (Au), silver (Ag), copper (Cu), aluminum (Al), molybdenum (Mo), titanium (Ti), tantalum (Ta), other appropriate materials, an alloy of the above-mentioned materials, a nitride of the above-mentioned materials, an oxide of the above-mentioned materials, or an oxynitride of the above-mentioned materials). Preferably, the connecting line 339 may stretch toward outside the pixel region 308 and be disposed corresponding to a black matrix pattern 342. (The black matrix pattern will be detailed in the following context.) So even if the connecting line 339 is made of a reflective material, an aperture ratio of the liquid crystal display panel is not influenced. In the other embodiments of the present invention, the connecting line 339 may be made of other conductive materials, such as a transparent conductive material which is the material of the pixel electrode 310, and be disposed in the pixel region 308 together. Or the connecting line 339 may be made of reflective material and be disposed in the pixel region 308.

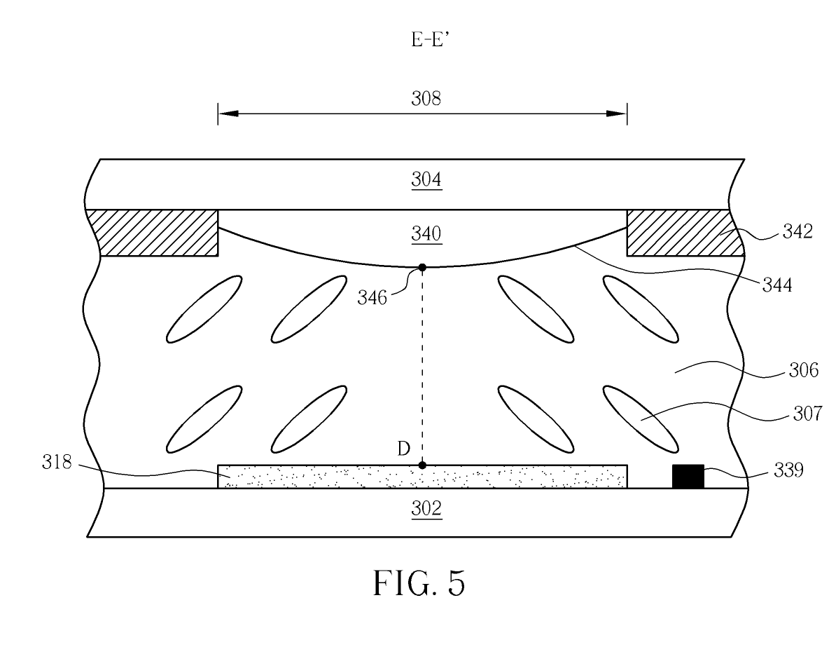

Please refer to FIG. 5. FIG. 5 is a schematic diagram illustrating a cross-sectional view of the pixel region of the liquid crystal display panel along the line E-E′ in FIG. 4 according to an embodiment of the present invention. As shown in FIG. 5, the liquid crystal display panel 300 in this embodiment further comprises a plurality of color filters 340 and a plurality of black matrix patterns 342 (For describing clearly, only a color filter 340 and a black matrix pattern 342 are illustrated in FIG. 5.), disposed between the second substrate 304 and the liquid crystal layer 306. Each of the black matrix patterns 342 is disposed on a periphery of each of the pixel regions 308 (please refer to FIG. 4 together) and surrounds each of the pixel regions 308. The color filter 340 is disposed inside the black matrix pattern 342. In other words, the color filter 340 is disposed on an area, which is not covered by the black matrix pattern 342, in the second substrate 304, and the color filter 340 corresponds to the pixel region 308. Please refer to FIG. 5, the color filter 340 comprises a curved surface 344 facing the liquid crystal layer 306, and the color filters 340 comprises an extreme thickness position 346 on the curved surface 344. In this embodiment, the curved surface 344 is a convex, and the extreme thickness position 346 is a position of a maximum thickness. One of the main characteristics of the present invention is that the maximum thickness position substantially overlaps the centroid of the first electrode 318 (point H) in a vertical projection direction.

Please refer to FIG. 4 again. When voltages are respectively applied to the first pixel electrode 318 and the second pixel electrode 320, the liquid crystal molecules 307 in the liquid crystal layer 306 will be aligned along the disposed direction of each of the branch electrodes (including the first branch electrodes 326, the second branch electrodes 332, and the third branch electrodes 334), and tilted toward the point H of the first electrode 318. In this embodiment, since the extreme thickness position 346 of the color filter 340 substantially overlaps the point H in a vertical projection direction, aligning directions toward the point H are generated on the liquid crystal molecules 307, and the liquid crystal molecules 307 are tilted along the directions of the arrows G in FIG. 4. In this situation, arrows F represent aligning directions of the liquid crystal molecules 307 generated by the first electrode 318, and arrows G represent aligning directions of the liquid crystal molecules 307 generated by the color filter 307. The aligning directions of the liquid crystal molecules 307 generated by the first electrode 318 are substantially identical with the aligning directions of the liquid crystal molecules 307 generated by the color filter 340. Therefore, the aligning directions of the liquid crystal molecules 307 may not be affected by the interaction between the pixel electrode 310 and the color filter 340, and the disclination issue generated by the non-uniform alignment of the liquid crystal molecules in prior art may be effectively improved.

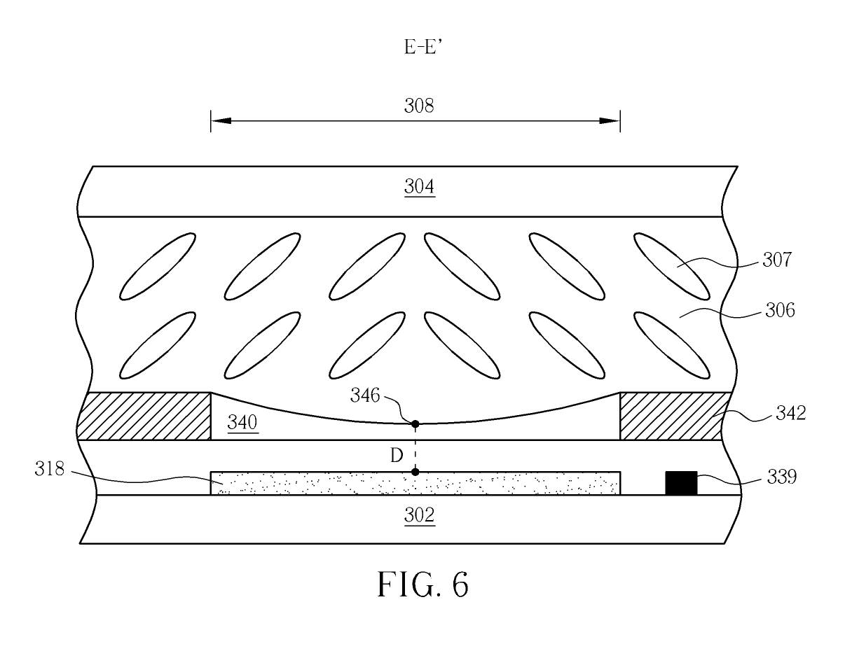

Please refer to FIG. 6. FIG. 6 is a schematic diagram illustrating a cross-sectional view of the pixel region of the liquid crystal display panel according to another embodiment of the present invention. As shown in FIG. 6, in another embodiment of the present invention, the color filter 340 and the black matrix pattern 342 may be disposed between the first electrode 318 and the liquid crystal layer 306, and that is different from the embodiment of FIG. 5, in which the color filter 340 and the black matrix pattern 342 are disposed between the second substrate 304 and the liquid crystal layer 306. In other embodiments, the color filter 340 and the black matrix pattern 342 may be disposed between the first electrode 318 and the first substrate 302. In this embodiment, the extreme thickness position 346 substantially overlaps the centroid of the first electrode 318 (point H) in a vertical projection direction. The curved surface 344 is a concave, and the extreme thickness position 346 is a position of a minimum thickness. In this situation, the aligning directions of the liquid crystal molecules 307 along the arrows G are still generated by the color filter 340, and the aligning directions along arrows G are substantially identical with the aligning directions along arrows F. Therefore, the disclination issue of the liquid crystal molecules may not be generated.

According to the descriptions above, the main characteristic of the present invention is overlapping the extreme thickness position 346 of the color filter 340 with the centroid of the first electrode 318 (which is also the centroid of the second electrodes 320) to make an effect to the influence on the alignment of the liquid crystal molecules 307 generated by the color filter 340 and the first electrode 318. In another embodiment of the present invention, the pixel region 308 may comprise more than one color filter 340. For example, the pixel region 308 may comprise two color filters 340, and the extreme thickness positions 346 of these two color filters 340 respectively correspond to the centroid of the first electrode 318 and the centroid of the second electrode 320. In this situation, the aligning directions of the liquid crystal molecules 307 generated by the first electrode 318 along arrows G are substantially identical with the aligning directions of the liquid crystal molecules 307 generated by the color filter 307 along arrows F. Therefore, the disclination issue of the liquid crystal molecules may not be generated. In other words, no matter how many the electrode patterns are and where the position of the electrode pattern is, as long as the extreme thickness position of the color filter corresponds to the center of the aligning directions of each liquid crystal molecules (in this embodiment, the center of the aligning directions is the centroid of the electrode pattern), the aligning directions of the liquid crystal molecules generated by the electrode pattern and the alignment directions of the liquid crystal molecules generated by the color filters may be substantially identical to avoid the disclination issue.

To summarize all the descriptions above, the influence of the curved surface of the color filter on the aligning direction of the liquid crystal molecules is considered in the present invention. When a predetermined voltage is applied to each of the pixel electrodes, the aligning directions of the liquid crystal molecules disposed above the first electrode are converged toward a center (or namely a predetermined center), and the extreme thickness position substantially overlaps the center to reduce the influence of the color filters on the alignment of the liquid crystal molecules to a lowest level. So the disclination of the liquid crystal molecules may be effectively avoided, and the display quality of the liquid crystal display panel may be effectively enhanced. In the present invention, overlapping the extreme thickness position of the color filter with the centroid of the first electrode is taken as an example to reduce the influence of the color filters on the alignment of the liquid crystal molecules to the lowest level. Therefore, the disclination issue of the liquid crystal molecules may be effectively avoided, and the display quality of the liquid crystal display panel may be effectively enhanced.

Those skilled in the art will readily observe that numerous modifications and alterations of the device and method may be made while retaining the teachings of the invention.

What is claimed is:

1. A liquid crystal display panel, comprising:
a first substrate and a second substrate, wherein the first substrate is disposed oppositely to the second substrate;
a liquid crystal layer, disposed between the first substrate and the second substrate, wherein the liquid crystal layer comprises a plurality of liquid crystal molecules;
a plurality of pixel regions, disposed on the first substrate and the second substrate, wherein each of the pixel regions at least comprises a main pixel region and a sub pixel region;
a plurality of pixel electrodes, disposed on the first substrate and disposed correspondingly to the pixel regions, wherein each of the pixel electrodes comprises:
a first electrode disposed in the main pixel region; and
a second electrode disposed in the sub pixel region, wherein the first electrode is electrically disconnected from the second electrode; and
a plurality of color filters, disposed between the first substrate and the second substrate, and each of the color filters corresponding to each of the pixel regions, wherein each of the color filters comprises a curved surface facing the liquid crystal layer, and each of the color filters comprises an extreme thickness position, and when a predetermined voltage is applied to each of the pixel electrodes, aligning directions of the liquid crystal molecules disposed above the first electrode are converged toward a center, and the extreme thickness position substantially overlaps the center in a vertical projection direction.

2. The liquid crystal display panel of claim 1, wherein the first electrode comprises:
at least two first main electrodes dividing the main pixel region into a plurality of regions, and a centroid of the first electrode being disposed in an intersection of the two first main electrodes; and
a plurality of first branch electrodes, an end of each of the first branch electrodes being connected to the first main electrode and the other end of each of the first branch electrodes being disposed apart from the first main electrode, wherein the first branch electrodes disposed in the same region are parallel to each other and stretch in an identical direction.

3. The liquid crystal display panel of claim 2, wherein the main pixel region is divided into at least four regions.

4. The liquid crystal display panel of claim 1, wherein the sub pixel region comprises a first sub pixel region and a second sub pixel region, and the main pixel region is disposed between the first sub pixel region and the second sub pixel region.

5. The liquid crystal display panel of claim 4, wherein the second electrode comprises:
at least two second main electrodes, disposed in the first sub pixel region, and dividing the first sub pixel region into a plurality of regions;
a plurality of second branch electrodes, disposed in the first sub pixel region, an end of each of the second branch electrodes being connected to the second main electrode and the other end of each of the second branch electrodes being disposed apart from the second main electrode, wherein the second branch electrodes disposed in the same region are parallel to each other and stretch in an identical direction;
at least two third main electrodes, disposed in the second sub pixel region, and dividing the second sub pixel region into a plurality of regions;
a plurality of third branch electrodes, disposed in the second sub pixel region, an end of each of the third branch electrodes being connected to the third main electrode and the other end of each of the third branch electrodes being disposed apart from the third main electrode, wherein the third branch electrodes disposed in the same region are parallel to each other and stretch in an identical direction; and
at least a connecting line, electrically connecting the second main electrode and the third main electrode.

6. The liquid crystal display panel of claim 5, wherein the first sub pixel region is divided into at least two regions, and the second sub pixel region is divided into at least two regions.

7. The liquid crystal display panel of claim 1, wherein the color filters are disposed between the second substrate and the liquid crystal layer.

8. The liquid crystal display panel of claim 7, wherein the curved surface of each of the color filters is a convex, and the extreme thickness position of each of the color filters is a position of a maximum thickness.

9. The liquid crystal display panel of claim 1, wherein the color filters are disposed between the pixel electrodes and the liquid crystal layer.

10. The liquid crystal display panel of claim 9, wherein the curved surface of each of the color filters is a concave, and the extreme thickness position of each of the color filters is a position of a minimum thickness.

11. The liquid crystal display panel of claim 8, further comprising a plurality of black matrix patterns disposed on the second substrate, and each of the black matrix patterns corresponding to and surrounding a border of each of the pixel region, wherein each of the color filters is disposed in each of the black matrix patterns.

12. The liquid crystal display panel of claim 10, further comprising a plurality of black matrix patterns disposed on the first substrate, and each of the black matrix patterns corresponding to and surrounding a border of each of the pixel region, wherein each of the color filters is disposed in each of the black matrix patterns.

13. The liquid crystal display panel of claim 1, wherein the center substantially corresponds to a centroid of the first electrode.
